(19) United States
(12) Patent Application Publication
(10) Pub. No.: US 2017/0123502 A1
(43) Pub. Date: May 4, 2017

(54) WEARABLE GESTURE CONTROL DEVICE AND METHOD FOR SMART HOME SYSTEM

(71) Applicant: Honeywell International Inc., Morristown, NJ (US)

(72) Inventors: Yi Wang, Shanghai (CN); Yekun Gao, Shanghai (CN); Xiaoguang Zhao, Shanghai (CN); Rongbao Nie, Shanghai (CN)

(21) Appl. No.: 15/336,514

(22) Filed: Oct. 27, 2016

(30) Foreign Application Priority Data
Oct. 30, 2015 (CN) 201510720423.5

(51) Int. Cl. G06F 3/01; G06F 1/16; H04L 12/28; G06K 9/00; H04W 4/00; H04L 29/08

(52) U.S. Cl. CPC G06F 3/017; H04W 4/008; H04L 67/125; H04L 12/2816; G06K 9/00087; G06F 3/015; G06F 1/163

(57) ABSTRACT

The present invention relates to a gesture control method for a smart home system, characterized in that it comprises the steps of: pre-defining each gesture; associating each predefined gesture with a control command for a smart home system; making a gesture and wirelessly transmitting a control command associated with the gesture in accordance with a wireless protocol; receiving the control command and performing a control operation associated with the gesture to the smart home system.

### TECHNICAL FIELD

The present invention relates to a wearable gesture control device and method, and more particularly to a wearable gesture control device and method for a home system.

### BACKGROUND

Smart home is a living environment for people, and using home as a platform to install a smart home system, to achieve a more secure family life, energy saving, intelligence, convenience and comfort. Smart home system is committed to providing users with “one-stop system solutions”, about visual intercom, security, information appliances control, air conditioning control, floor heating control, lighting control, curtain control, scene linkage and other functions Integration, in order to achieve real smart home system features: safe, comfortable and convenient.

With the popularity of smart home systems, how to more comfortably control the smart home system has also become a need. It has now been developed to control various household appliances, such as control lights, locks and thermostats, in smart home systems by using smart controllers. The smart controller may be controlled by a local graphical user interface (GUI) and a remote mobile application (APP), which may be a mobile device such as a mobile phone. With more and more rooms and household appliances in smart home systems, in order to use the existing smart controller to control a household appliance, the user has to find the smart controller by operating the APP to carry out remote operation or directly come in front of home appliances to direct operation, and cannot be anytime, anywhere, arbitrary control of the household appliances in smart home systems.

The disadvantages of conventional control methods are the following:

1. As the user cannot always carry the smart controller, it cannot be at any time by moving APP to control household appliances;
2. As the growing number of home appliances, through the local GUI to the locale control will make the user operation is not convenient, to the user a bad user experience.

Thus, conventional smart home system control methods do not provide a satisfactory operational experience for the user, requiring a user control experience that is faster, more convenient, less prone to misuse, and wherever and whenever it is needed.

### SUMMARY OF THE INVENTION

In order to overcome one or more of the deficiencies in the prior art, the present invention provides a new control method and device that enables a user to quickly, conveniently and accurately control a desired target home appliance and to accurately control.

In accordance with one aspect of the present invention, there is provided a wearable gesture control method for an smart home system, the method comprising the steps of:

pre-defined for each gesture;
associating each predefined gesture with a smart home system control command;
making a gesture and wirelessly transmitting a control command associated with the gesture in accordance with a wireless protocol;
receiving a control command and performing a control operation associated with the gesture to the smart home system.

In accordance with one aspect of the present invention, there is provided a wearable gesture control device for a smart home system, the device comprising:

an axis acceleration sensor for tracing the gesture and translating it into a control command associated with the gesture; and
a wireless transmitter for wirelessly transmitting the control command associated with the gesture in accordance with the wireless protocol.

According to the technical solution of the present invention, the user's operation operates at any time in the smart home system, and the household electric appliance in the room can be controlled by a simple gesture, giving the user a quick, misuse and anytime, anywhere user control experience.

The wearable gesture control device of the present invention has the following advantages:

1. The use of new gesture control method to replace the traditional point-and-click control method, the user can more quickly and accurately control the target household appliances;
2. Gesture operation will give users a more intuitive, natural feeling, thus greatly enhancing the user experience;
3. Wearable way allows users to carry anywhere, anytime, anywhere control of the target household appliances;
4. The control command associated with the gesture can be customized to make the control method more flexible.

### BRIEF DESCRIPTION OF THE DRAWINGS

The accompanying drawings are provided to provide a further understanding of the invention and are incorporated in and constitute a part of the specification, together with embodiments of the invention, for the purpose of explaining the invention and are not intended to be limiting of the invention. In the drawings:

FIG. 1 is a schematic diagram illustrating a wearable gesture control device for a smart home system according to an embodiment of the present invention;

FIG. 2 is a diagram illustrating the operational principle of a wearable gesture control device for a smart home system according to an embodiment of the present invention;

FIG. 3 is a flow diagram of a gesture control method for an smart home system according to an embodiment of the present invention.

### DETAILED DESCRIPTION

In the present specification, certain terms are used throughout this document to refer to particular system components. As will be appreciated by those skilled in the art, the same components are generally indicated by different designations, and thus the present application is not intended to distinguish those components that differ only in name, but not in function. In this application, the terms “comprising”, “including” and “having” are used in an open form and should therefore be interpreted as meaning “including but not limited to . . . ”. In addition, the terms “basically”, “substantially” or “approximately” as may be used herein refer to industry accepted tolerances for corresponding terms. As used herein, the term “coupled” includes both direct coupling and indirect coupling via another component, element, circuit, or module, wherein for indirect coupling, components, elements, circuits, or modules intervened therebetween do not change the information of the signal, but can adjust its current level, voltage level, and/or power level. The inferred coupling (e.g., where one element is coupled to another element by inference) includes both direct and indirect coupling between the two elements in the same “coupling” manner.

In the following description, for purposes of explanation, numerous specific details are set forth in order to provide a thorough understanding of the present invention. It will be apparent, however, to one skilled in the art, that the apparatus, method and device of the present invention may be practiced without these specific details. The reference to an “embodiment”, “example” or the like in this specification means that a particular feature, structure, or characteristic described in connection with the embodiment or example is included in at least that embodiment or example, but not will necessarily be included in other embodiments or examples. The phrases “in one embodiment”, “in a preferred embodiment” or various instances of similar wordings in various places in the specification are not necessarily all referring to the same embodiment.

The invention will be further described in conjunction with the preferred embodiments and the accompanying drawings.

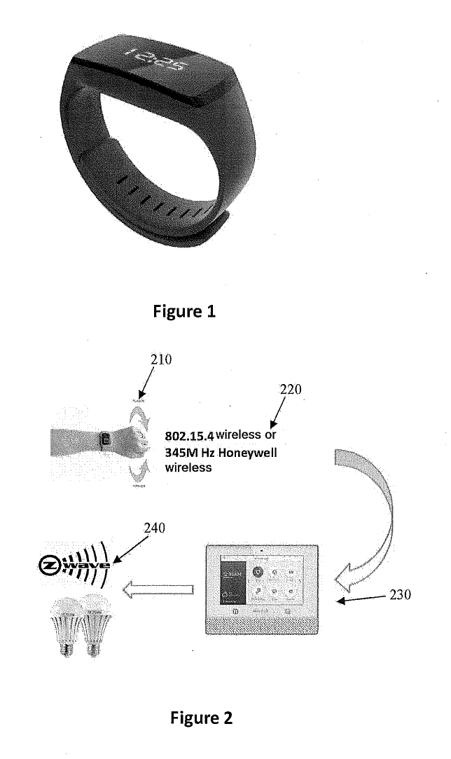

FIG. 1 is a schematic diagram illustrating a wearable gesture control device for a smart home system according to an embodiment of the present invention. The wearable gesture control device includes an axis acceleration sensor, preferably a 6-axis acceleration sensor, for tracing gestures and translating them into gesture-related commands, including turning the wrist to the left, turning the wrist to the right, turn the wrist full circle to the left, turn the full circle to the right and cross wrist, etc.; and a wireless transmitter for wirelessly transmitting a command associated with the gesture in accordance with a wireless protocol, the wireless protocol being 802.15.4 protocol and 345 Mhz Honeywell wireless protocol, the 802.15.4 protocol can be such as BLE protocol and Zigbee protocol.

The wearable gesture control device may further include a fingerprint identification module for identifying the identity of the user of the wearable gesture control device.

The wearable gesture control device may also include a timing module that is used as an electronic clock.

The wearable gesture control device may also include a health module to monitor a health status of the user of the wearable gesture control device.

The wearable gesture control device may further comprise a GPS positioning module to locate the geographical position of the user of the wearable gesture control device.

The control commands may include lighting control, curtain control, appliance control, air conditioning control, heating control, network control, and telephone control and so on. Control can also be categorized in other ways.

FIG. 2 is a schematic diagram illustrating the operational principle of a wearable gesture control device for a smart home system according to an embodiment of the present invention. The wearable gesture control device in FIG. 2 is predefined as turning the wrist to the left to be “on” and turning the wrist to the right to be “off”. After the user has selected the target home appliance, the wrist 210 is turned to the left, wirelessly sending an “on” command 220 in accordance with the wireless protocol, and the smart home system receives the turn-on command 230 and turns on the Zwave device 240. Instead, the user turns his wrist to the right to turn off the Zwave device in the smart home system. The control gesture may be associated with any control command.

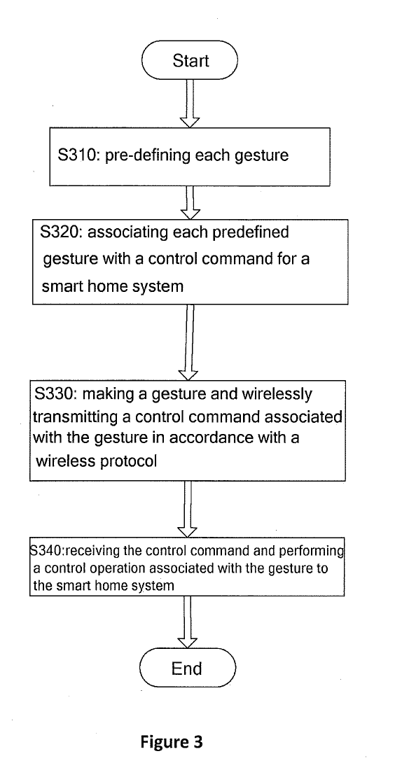

FIG. 3 is a flow diagram of a gesture control method for a smart home system according to an embodiment of the present invention. At step 310, each gesture is predefined. At step 320, each predefined gesture is associated with a smart home system control command. At step 330, a gesture is made and the control command associated with the gesture is wirelessly transmitted in accordance with the wireless protocol. At step 340, a control command is received and a control operation associated with the gesture is made to the smart home system.

The various gestures described above are merely exemplary, and other gestures, such as gestures associated with shaking, turning, rotation, crossover, and the like, can also be used. Different gesture operations are provided so as to correspond to different functions so as to ensure that each gesture does not cause a functional conflict.

The control method of the present invention allows the user to more quickly and accurately position the desired household appliance anywhere, anytime, to achieve the desired control over the traditional control method. The control method of the present invention, in combination with the gesture operation, can provide a better experience to the user. The control method of the present invention can provide a wider operating range when the user operates the smart home system. In addition, pre-defined gesture operation can effectively reduce the user's misuse. Therefore, the control method of the present invention can greatly enhance the efficiency and accuracy of controlling the smart home system while enhancing the user experience.

Note that the present preferred embodiment may be implemented in hardware, software, firmware, or a combination thereof. In the various embodiments(s), the device components are implemented in software or firmware stored in memory and executed by the appropriate instruction execution system. If implemented in hardware, as in some embodiments, device components may be implemented with any of the following techniques, or a combination thereof, that are well known in the art: one or more discrete logic circuits having logic gates for implementing logic function on a data signal, an application specific integrated circuit (ASIC) with suitable combinational logic gates, programmable gate array (s) (PGA), field programmable gate array (FPGA), and the like.

The software component may include an ordered list of executable instructions for implementing the logic functions, which may be embodied in any computer readable medium for use by or in connection with an instruction execution system, apparatus, or device, the instruction execution system, apparatus, or device, such as a computer-based system, a processor-containing system, or other system capable of acquiring and executing instructions from an instruction execution system, apparatus, or device. In addition, the scope of the present disclosure encompasses functions embodying one or more embodiments in the logic embodied in hardware or software constructed media.

The foregoing disclosure of embodiments of the present disclosure has been presented for illustrative and illustrative purposes. It is not intended to be exhaustive or to limit the disclosure to the precise forms disclosed. Numerous variations and modifications of the embodiments described herein will be apparent to those of ordinary skill in the art in light of the above disclosure. It is to be noted that the above examples are not intended to be limiting. Additional embodiments of apparatus, methods, and device that may include many of the features described above are also contemplated. Other apparatus, methods, device, features and advantages of the present disclosure will become more apparent to those skilled in the art after studying the drawings and detailed description. It is intended that all such other apparatus, methods, devices, features and advantages be included within the scope of the present invention.

Conditional language such as “capable”, “may”, or “can” is intended generally to convey the meaning of a particular word that some embodiments may include, but do not necessarily include, certain features, elements, and/or steps, unless it is otherwise expressly stated or otherwise within the context in which it is used. Accordingly, such conditional language is not intended to imply in any way that one or more embodiments must include features, elements, and/or steps.

Any processing instructions or blocks in the flowcharts should be construed to represent code portions, or segments, modules that include one or more executable instructions for implementing a particular logic function or step in the process, and replace implementations are included within the scope of the preferred embodiments of the present disclosure, where the functions may not be performed in the order shown or discussed, including substantially simultaneously or in reverse order, depending on the functionality involved, such as will be understood by those skilled in the art to which this disclosure pertains.

While some embodiments have been described in detail above, other modifications are possible. For example, to achieve the desired results, the logic flow depicted in the figures need not be in the specific order shown, or in a sequential order. Other steps may be provided, or certain steps may be eliminated from the described processes, and additional components may be added to or removed from the described systems. Other embodiments are within the scope of the following claims.

1. A gesture control method for a smart home system, characterized in that it comprises the steps of:
pre-defining each gesture;
associating each predefined gesture with a control command for a smart home system;
making a gesture and wirelessly transmitting a control command associated with the gesture in accordance with a wireless protocol;
receiving the control command and performing a control operation associated with the gesture to the smart home system.

2. The method of claim 1, wherein the making the gesture comprises:
turning the wrist to the left, turning the wrist to the right, turn the wrist full circle to the left, turn the full circle to the right and cross the wrist.

3. The method of claim 1, wherein the wireless protocol may be a 802.15.4 protocol and a 345 Mhz Honeywell wireless protocol.

4. The method according to claim 3, wherein the 802.15.4 protocol comprises: a BLE protocol and a Zigbee protocol.

5. A wearable gesture control device for a smart home system, comprising:
an axis acceleration sensor for tracing the gesture and translating it into a control command associated with the gesture; and
a wireless transmitter for wirelessly transmitting the control command associated with the gesture in accordance with the wireless protocol.

6. The device of claim 5, wherein the axis acceleration sensor is a 6-axis acceleration sensor.

7. The device of claim 5, further comprising a fingerprint identification module to identify the identity of a user of the wearable gesture control device.

8. The device of claim 5, further comprising a timing module for use as an electronic clock.

9. The device of claim 5, further comprising a health module to monitor a health status of the user of the wearable gesture control device.

10. The device of claim 5, further comprising a GPS positioning module to locate the geographic location of the user of the wearable gesture control device.

11. The device of claim 5, wherein the wireless protocol may be a 802.15.4 protocol and a 345 Mhz Honeywell wireless protocol.

12. The device of claim 11, wherein the 802.15.4 protocol comprises: a BLE protocol and a Zigbee protocol.
